(19) United States
(12) Patent Application Publication
(10) Pub. No.: US 2020/0100980 A1
(43) Pub. Date: Apr. 2, 2020

(54) PRESSURE GRADIENT INTENSIFIER HOLSTER

(71) Applicant: Victor Julio Perez, Santa Clara, CA (US)

(72) Inventor: Victor Julio Perez, Santa Clara, CA (US)

(21) Appl. No.: 16/588,966

(22) Filed: Sep. 30, 2019

Related U.S. Application Data
(60) Provisional application No. 62/739,420, filed on Oct. 1, 2018.

(51) Int. Cl. A61H 7/00

(52) U.S. Cl. CPC A61H 7/001; A61H 2205/08; A61H 2201/165

(57) ABSTRACT

There is a holster or bra that exerts focalized pressure on surfaces of the torso. At least one pressure component is mated to the anterior portion or posterior portion of the holster or bra. The holster exerts focalized pressure by using various mechanisms such as springs. The pressure component can be in the form of an electronic tablet. There is also a method of exerting focalized pressure against surfaces of the torso.

### PRIORITY CLAIM

This application claims the benefit of U.S. Provisional Application No. 62/739,420 filed Oct. 1, 2018, which is hereby incorporated by reference in its entirety.

### BACKGROUND OF THE INVENTION

### 1. Field of the Invention

The present invention relates to wearable devices; more particularly the present invention relates to holsters that support wearable devices, whereby the wearable devices can exert focal pressure on strategic areas on a human body.

### 2. Background

There are numerous health and lifestyle challenges that occur along the mediastinum region of the human torso (e.g. dangerous myxedemas, fat deposits encroaching the pericardium and peritoneum). Many of said challenges can be solved with methods that require facilitating prolonged focal pressure on the affected areas.

Currently, there exist sturdy holsters, as well as flimsy ones. These holsters wrap around a portion of the body so the pressure exerted is dispersed throughout the wrap and less forceful on the targeted area. For example, the wrap-around holster used for the torso has to engage the flanks, which means that the pressure exerted by the wrap-around holster is distributed throughout the torso and is not focalized. The current wrap-around holsters cannot induce useful gradient pressure and temperature between the torso's mediastinum and the torso's flank.

Most wrap-around bras resort to wide straps wrapping around the flanks of the torso and use narrow straps that rest on the shoulders. Too frequently, wrap-around bras leave marks on the flanks and shoulders and contribute to back pain and shoulder pain. The current wrap-around bras also make the user feel uncomfortable about their cleavage. Even though the bra industry offers alternative bras without shoulder-straps or bras that have wider flank-straps, such alternatives do not address the pain and discomfort that arise from using such a product.

Accordingly, there is a need for a holster that can exert focal pressure along the sternal and interscapular areas (these areas correspond to the ventral aspect and dorsal aspect of the torso).

### SUMMARY

An object of the present invention is to exert focalized pressure along the ventral or dorsal aspect of the torso of a human body, according to an embodiment of the present invention.

An object of the present invention is to provide a fashionable holster that can be worn by the user, according to an embodiment of the present invention.

Yet another object of the present invention is to send and receive electronic signals using the pressure component, according to an embodiment of the present invention.

In some embodiments, there is a holster that exerts focalized pressure comprising at least two supporting units configured for wearing on each shoulder of a user, the at least two supporting units having a length between an outer edge and an inner edge, a width between a body facing side and an outside facing side, an anterior portion extending to a posterior portion starting from an anterior edge and ending at a posterior edge. There is at least one pressure component, the at least one pressure component having a plurality of edges, a body facing surface and an outside facing surface. There is a first plurality of edges of the at least one pressure component, which is in contact with the inner edge of the anterior portion of a first supporting unit of the at least two supporting units. There is a second plurality of edges of the at least one pressure component, which is in contact with the inner edge of the anterior portion of a second supporting unit of the at least two supporting units. The first supporting unit of the at least two supporting units and the second supporting unit of the at least two supporting units exert a clamping effect against a mediastinum region of a human torso.

According to some embodiments there is a holster that exerts focalized pressure against surfaces of a mediastinum comprising a supporting unit worn on a shoulder. There is a supporting unit having a length between an outer edge and an inner edge, a width between a body facing side and an outside facing side, an anterior portion extending to a posterior portion beginning from an anterior edge and ending at a posterior edge.

According to some embodiments, there is a method of exerting focalized pressure against surfaces of a mediastinum, the method comprising, a) aligning an anterior portion of a first supporting unit with a ventral aspect of a torso, b) placing the first supporting unit over a first shoulder, c) repeating steps a) and b) with a second supporting unit over a second shoulder, d) aligning the first supporting unit with the second supporting unit, g) mating a first pressure component into the first supporting unit and the second supporting unit.

These features, advantages and other embodiments of the present invention are further made apparent, in the remainder of the present document, to those of ordinary skill in the art.

### BRIEF DESCRIPTION OF THE DRAWINGS

In order to more fully describe embodiments of the present invention, reference is made to the accompanying drawings. These drawings are not to be considered limitations in the scope of the invention, but are merely illustrative.

FIG. 1 illustrates a front view of the sagittal holster system that exerts focalized pressure comprising the sagittal holster and at least one pressure component, according to some embodiment of the present invention.

FIG. 2 illustrates a back view of the sagittal holster system that exerts focalized pressure comprising the sagittal holster and at least one pressure component, according to some embodiment of the present invention.

FIG. 3 illustrates a perspective view of the sagittal holster system that exerts focalized pressure comprising two sagittal arches and four pressure components, according to some embodiment of the present invention.

FIG. 4 illustrates an exploded view of the sagittal holster system, according to some embodiment of the present invention.

FIG. 5 illustrates a front view of the sagittal bra system that exerts focalized pressure comprising a sagittal bra and at least one pressure component, according to some embodiment of the present invention.

FIG. 6 illustrates a back view of the sagittal bra system that exerts focalized pressure comprising a sagittal bra and at least one pressure component, according to some embodiment of the present invention.

FIG. 7 illustrates an exploded front view of a sagittal bra system that exerts focalized pressure comprising a sagittal bra and at least one pressure component, according to some embodiment of the present invention.

FIG. 8A illustrates a perspective view of the pressure component, according to some embodiment of the present invention.

FIG. 8B illustrates a front view of the pressure component, according to some embodiment of the present invention.

FIG. 9 illustrates a cross sectional view of the sagittal arches and a pressure component along an area of the sagittal arch without an opening, according to some embodiment of the present invention.

FIG. 10 illustrates a cross sectional view at an opening of the sagittal holster or sagittal bra according to some embodiment of the present invention.

FIG. 11 illustrates a detailed view of A in FIG. 10 after the fastener secures a pressure component to a sagittal arch, according to some embodiment of the present invention.

FIG. 12 illustrates a detailed view of the concave region of the inner edge of the sagittal arch between the openings, according to some embodiment of the present invention.

FIG. 13 illustrates a detailed view of the concave region of the inner edge of the sagittal arch at an opening, according to some embodiment of the present invention.

FIG. 14 illustrates an exploded view of the fastener, according to some embodiment of the present invention.

FIG. 15 illustrates a top view of a flattened left and right sagittal arch and two pressure components, according to some embodiment of the present invention.

FIG. 16 illustrates a top view of a flattened left cup holding arch and right cup holding arch and two pressure components, according to some embodiment of the present invention.

FIG. 17A illustrates a front view of the sagittal holster system, according to some embodiment of the present invention.

FIG. 17B illustrates a front view of the sagittal bra system, according to some embodiment of the present invention.

FIG. 17C illustrates a front view of some embodiment of the sagittal bra system, according to some embodiment of the present invention.

FIG. 18A illustrates a back view of the sagittal holster system, according to some embodiment of the present invention.

FIG. 18B illustrates a back view of the sagittal bra system, according to some embodiment of the present invention.

FIG. 18C illustrates a back view of another sagittal bra system, according to some embodiment of the present invention.

FIGS. 19A-19D illustrates some embodiments of fixed height sagittal arches, according to some embodiment of the present invention.

FIGS. 20A-20D illustrates some embodiments of variable height sagittal arches, according to some embodiment of the present invention.

### DETAILED DESCRIPTION OF SPECIFIC EMBODIMENTS

The description above and below and the drawings of the present document focus on one or more currently preferred embodiments of the present invention and also describe some exemplary optional features and/or alternative embodiments. The description and drawings are for the purpose of illustration and not limitation. Those of ordinary skill in the art would recognize variations, modifications, and alternatives. Such variations, modifications, and alternatives are also within the scope of the present invention. Section titles are terse and are for convenience only.

The right sagittal arch 2a and left sagittal arch 2b can collectively be called sagittal arch or sagittal arches. The right cup holding arch 54a and left cup holding arch 54b can collectively be called cup holding arch or cup holding arches. Torso and mediastinum can be used interchangeably as the torso also comprises the mediastinum. The anterior mediastinum, middle mediastinum, and posterior mediastinum can be referred to simply as mediastinum.

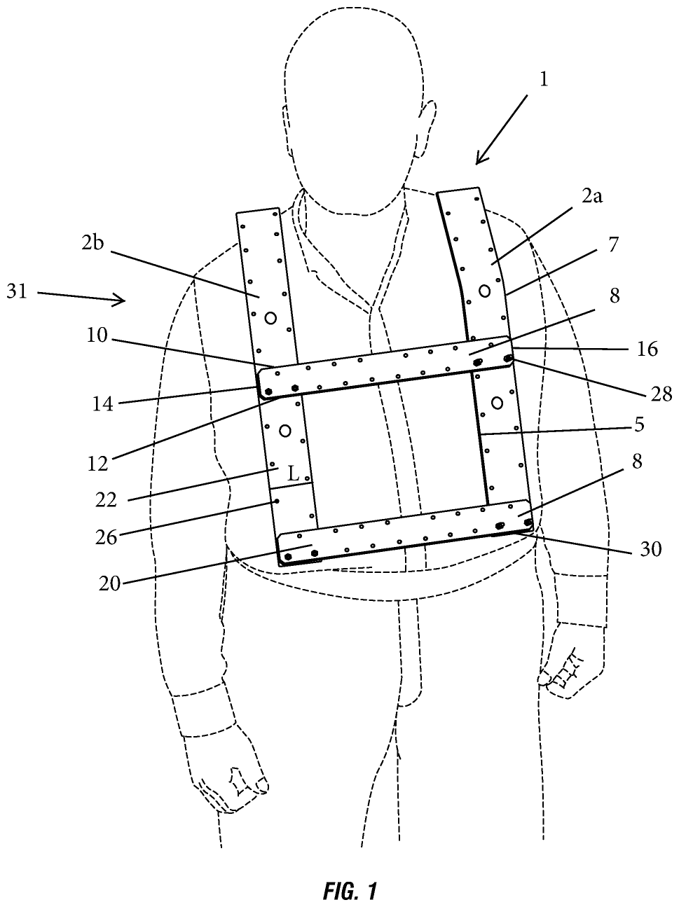

FIG. 1 illustrates a front view of the sagittal holster system that exerts focalized pressure comprising the sagittal holster 1 and at least one pressure component 8, according to some embodiment of the present invention. The sagittal holster 1 comprises two sagittal arches, a right sagittal arch 2a and a left sagittal arch 2b. The right sagittal arch 2a and the left sagittal arch 2b can be collectively called sagittal arches 2. The sagittal holster system is worn by a user and the dimensions of the sagittal arches 2a, 2b can vary. In FIG. 1, the anterior edge 30 is located generally at the epigastrium. The right sagittal arch 2a and left sagittal arch 2b each have an inner edge 5 and outer edge 7. The distance between the inner edge 5 and outer edge 7 is the length of the sagittal arches 2a, 2b. As illustrated in FIG. 1, there is a chest region 31 of the sagittal holster 1. The chest region 31 is worn substantially over the ventral aspect of the user.

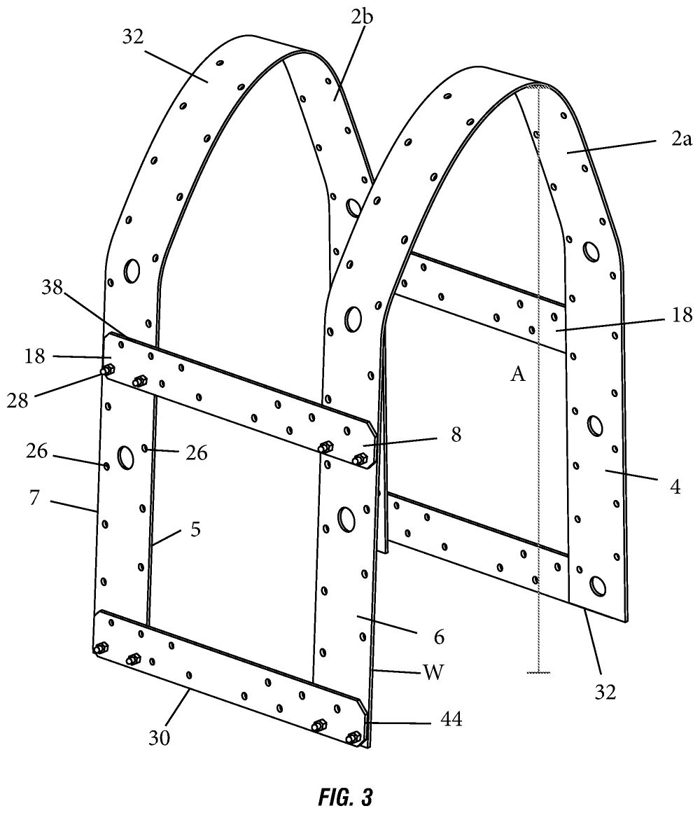

In some embodiments, the pressure components 8 illustrated in FIG. 1 comprise a top edge 10, a bottom edge 12, a right edge 16, a left edge 14, a body facing surface 18 (not shown, see FIG. 3), an outside facing surface 20, a top surface 38 (not shown, see FIG. 3), bottom surface 40, left surface 42 (not shown, see FIG. 8A), and right surface 44. The length of the pressure component 8 refers to the distance between the left edge 14 and right edge 16 of the pressure component 8. The width of the pressure component 8 refers to the distance between the body facing surface 18 and the outside facing surface 20 of the pressure component 8 (not shown, see FIG. 3). The height of the pressure component 8 refers to the distance between the top edge 10 and the bottom edge 12 of the pressure component 8. The location of the pressure components 8 is adjustable. The pressure components 8 can be worn along the torso depending on the desired location by the user. For example, if the user desires to wear the pressure component about the sternal region, the user can secure the pressure component 8 using the fasteners 28 and openings 26 at that location on the right sagittal arch 2a and left sagittal arch 2b. In some embodiments, the fasteners 28 are screws; however, other types of fasteners can be contemplated. At least one pressure component 8 can be worn in a sagittal holster system and the one pressure component 8 can be worn on the dorsal aspect of the torso or the ventral aspect of the torso of the user. The pressure component 8 can be worn horizontally or vertically along the torso of the user.

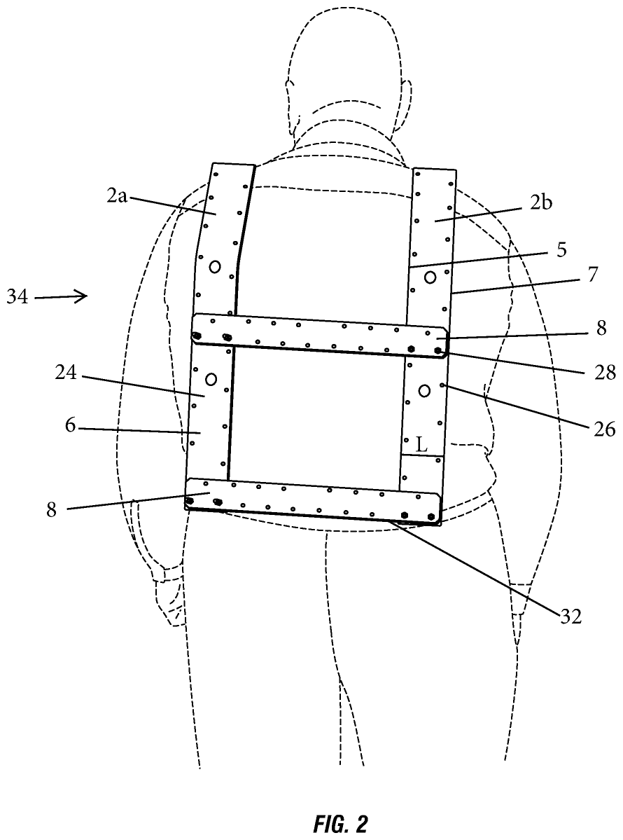

FIG. 2 illustrates a back view of the sagittal holster system illustrated in FIG. 1, according to some embodiments of the present invention. The sagittal holster system is worn by a user and the dimensions of the sagittal arches 2a, 2b can vary. The sagittal holster 1 can be heat treated and spring assisted. In some embodiments such as those illustrated in FIG. 2, the posterior edge 32 is located generally at the lumbar region. The distance between the anterior edge 30 and the posterior edge 32 is the height of the sagittal arches 2a, 2b. The locations of the pressure components 8 are adjustable. The pressure components 8 can be worn along the torso depending on the desired location by the user. For example, if the user desires to wear the pressure component about the interscapular region, the user can secure the pressure component 8 using the fasteners 28 and openings 26 at that location on the right sagittal arch 2a and left sagittal arch 2b. In some embodiments, for example in FIG. 2, the user unscrews the fastener 28 at all the connecting points to release the pressure component 8 from the right sagittal arch 2a and left sagittal arch 2b. Once the pressure component 8 is detached, the user can move the pressure component 8 to another opening 26 on the right sagittal arch 2a and left sagittal arch 2b and refasten using the fastener 28. The pressure component 8 can be worn horizontally or vertically along the torso of the user. As illustrated in FIG. 2, there is a back region 34 of the sagittal holster 1. The back region 34 is worn substantially over the dorsal aspect of the user. In some embodiments, the pressure component 8 is secured substantially flat against the outside facing side 6 of the right sagittal arch 2a and left sagittal arch 2b. However, as further described below, the pressure component 8 can secure substantially flat inside a channel 36 located on the right sagittal arch 2a and left sagittal arch 2b. Once the pressure component 8 is located in the channel 36, a fastener 28 is used to secure it.

FIG. 3 illustrates a perspective view of the sagittal holster system that exerts focalized pressure comprising two sagittal arches 2a, 2b and four pressure components 8, according to some embodiments of the present invention. The two sagittal arches 2a, 2b can be mirror images of each other. As illustrated in FIG. 3, there is a shoulder region 32 of the sagittal holster 1. The shoulder region 32 is worn substantially over the shoulder of the user. The distance “A” of the embodiment illustrated in FIG. 3 is about 16 inches.

The widest distance between the chest region 31 and the back region 34 is about 11 inches. The right sagittal arch 2a is worn over the shoulder on the left shoulder of the user and the left sagittal arch 2b is worn over the shoulder on the right shoulder of the user. The sagittal arch 2 has a body facing side 4 and an outside facing side 6. When the sagittal arch 2 is worn by the user, the body facing side faces the direction of the user. When the sagittal arch 2 is worn by the user, the outside facing side 6 faces the environment.

Each sagittal arch 2 has an inside edge 5 and an outer edge 7. The inside edge 5 is the edge proximal to the center of the user and the outer edge 7 is the edge distal to the center of the user. The length “L” of the sagittal arch 2 is the distance between the outer edge 7 and the inner edge 5 of the holster 2. The width “W” of the sagittal arch 2 is the distance between the outside facing side 6 and the body facing side 4. The sagittal arch 2 has an anterior edge 30 located at the anterior portion 22 of the sagittal arch 2 and a posterior edge 32 located at the posterior portion 24 of the sagittal arch 2. The anterior edge 30 is the edge located at the front of the user when the sagittal arch 2 is worn. The posterior edge 32 is the edge located at the back of the user when the sagittal arch 2 is worn. The height of the sagittal arch 2 is the distance between the anterior edge 30 and the posterior edge 32. The height of the sagittal arch 2 can be different in embodiments. For example, in some embodiments, the height can be the distance between the sternal region to the lumbar region of the user. In some embodiments, the height can be about 36 inches.

Parallel to the inner edge 5 are a plurality of openings 26 that assist in aligning the sagittal arch 2 with the pressure component 8. In some embodiments, the openings 26 can be about ¼ inch in diameter. However, other diameters can be contemplated. The openings 26 are located at a distance away from the inner edge 5. The opening 26 and fastener 28 allows the pressure component 8 to properly align with the right sagittal arch 2a and left sagittal arch 2b. In the embodiment shown in FIG. 3, the fasteners 28 attaching the pressure component 8 to the right sagittal arch 2a and left sagittal arch 2b are screws. However, in some embodiments, other types of fasteners 28 can be contemplated. Furthermore, as illustrated in the embodiment of FIG. 3, the pressure component 8 does not slide into a channel 36 located on the inner edge 5 of the right sagittal arch 2a and left sagittal arch 2b. Instead the pressure component 8 is substantially flat over the right sagittal arch 2a and left sagittal arch 2b.

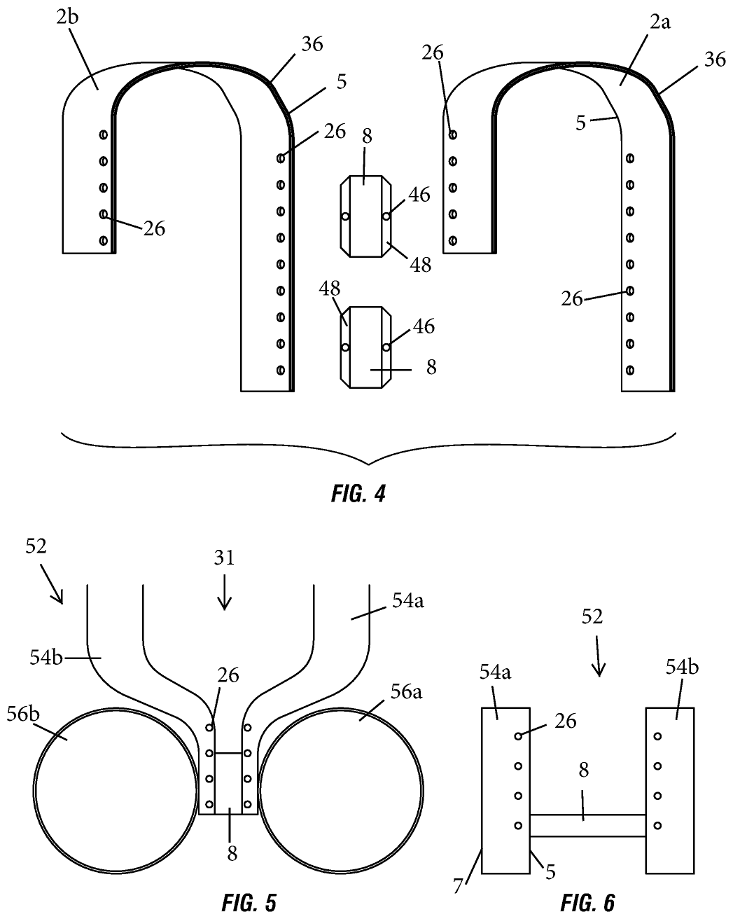

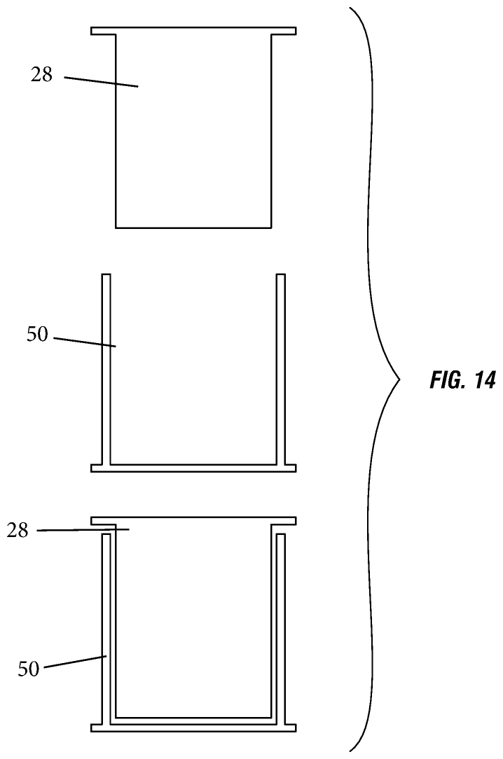

FIG. 4 illustrates an exploded view of the sagittal holster system, according to some embodiments of the present invention. In some embodiments, the right sagittal arch 2a and left sagittal arch 2b have channels 36. The fastener 28 (not shown, see FIG. 14) is inserted into the cavity 46 located on the pressure component 8. The pressure component 8 attaches to the sagittal arches 2a, 2b when the fastener is inserted and secured in the opening 26. In some embodiments, the fastener 28 can be magnetized, a binding bolt, snap on, posts with screw, etc. The fastener 28 can mate with a receiver 50 (not shown, see FIG. 14) at the inner edge 5 of the sagittal arch 2. However, in some embodiments where the fastener 28 is a screw, there is no need for a receiver 50 because the user screws the fastener 28 into the threads located within the opening 26. Depending on the type of fastener 28 used, the corresponding opening 26 will differ. In some embodiments, if the fastener 28 is a magnet, then the receiver 50 will comprise of a mating magnet.

In some embodiments, the sagittal holster system as illustrated in FIG. 4 can be worn as an undergarment or over garment. Some embodiments can be luxury sagittal holsters 1, for example made of platinum or gold. There can be utility sagittal holsters 1 comprising pockets to carry essential items. There can also be promotional sagittal holster 1 with stickers and logos of corporation such as sports fan sagittal holster, or fashionable sagittal holster.

In some embodiments as illustrated in FIG. 4, the pressure components 8 are worn in a vertical orientation relative to the user. The pressure components 8 have ridges 48 which slide into the channel 8 of the right sagittal arch 2a and left sagittal arch 2b.

FIG. 5 illustrates a front view of the sagittal bra system that exerts focalized pressure comprising a sagittal bra 52 and at least one pressure component 8, according to some embodiments of the present invention. The sagittal bra 52 comprises a right cup holding arch 54a and a left cup holding arch 54b. The right cup holding arch 54a and a left cup holding arch 54b can be collectively called cup holding arches 54. The sagittal bra system is worn by a user and the dimensions of the cup holding arches 54 can vary. The right cup holding arch 54a and the left cup holding arch 54b can be flat, slim and rigid and it can be made from various materials, such as stainless steel, fiber glass, plastic, brass, metallic, or titanium. The sagittal bra 52 can also be made from carbon fiber or molded plastic.

The right cup holding arch 54a connects to the right cup 56a and the left cup holding arch 54b connects to the left cup 56b. At the chest region 31, there is a pressure component 8 that connects to the cup holding arches 54a, 54b using fasteners 28 inserted through the opening 26 and cavity 46.

FIG. 6 illustrates a back view of a sagittal bra system that exerts focalized pressure comprising a sagittal bra 52 and at least one pressure component 8, according to some embodiments of the present invention. As shown in FIG. 6, the pressure component 8 can be worn in a horizontal position relative to the torso. However, the pressure component 8 can also be worn in a vertical position relative to the torso. The locations of the pressure components 8 are adjustable. The pressure components 8 can be worn along the torso depending on the desired location by the user. For example, if the user desires to wear the pressure component about the sternal region, the user can secure the pressure component 8 using the fasteners 28 and openings 26 at that location on the right cup holding arch 54a and left cup holding arch 54b.

As illustrated in FIG. 6, the back region 34 of the right cup holding arch 54a and left cup holding arch 54b are about 2 inches in length. When the pressure component 8 is worn between the right cup holding arch 54a and left cup holding arch 54b, the length of the pressure component 8 is about 5 inch and the height is about 1 inch. The length is measured from the distance between the outer edge 7 and inner edge 5.

The sagittal bra 52 can be reconfigured by using cups of different diameters. It can also be reconfigured by using pressure components 8 of different sizes. The pressure component 8 is secured to the right cup holding arch 54a and left cup holding arch 54b similar to how the pressure component 8 is secured to the sagittal holster 2a, 2b.

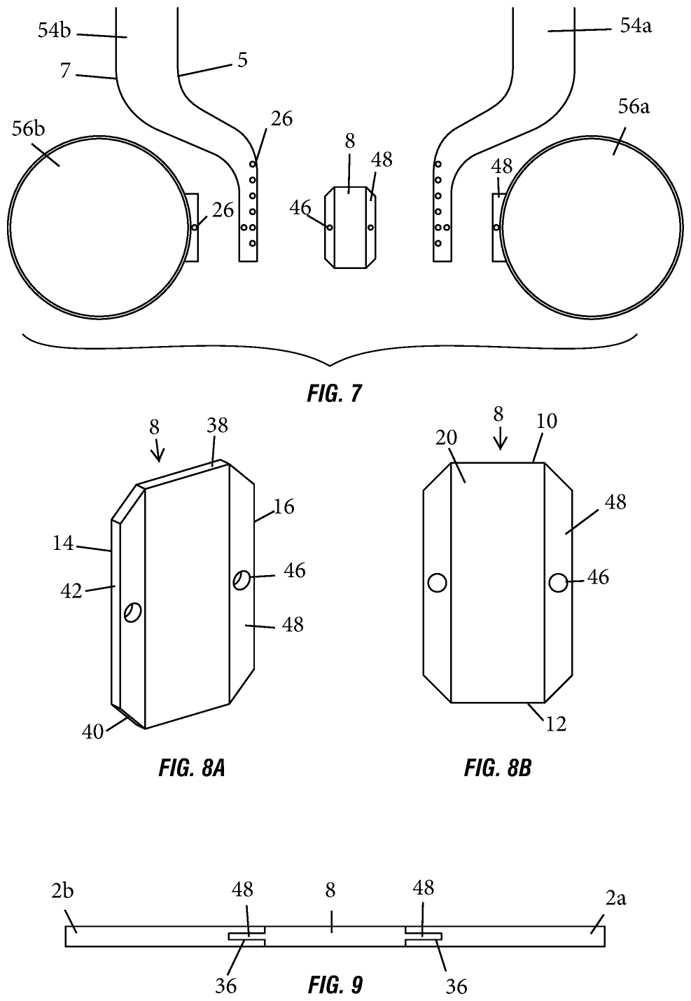

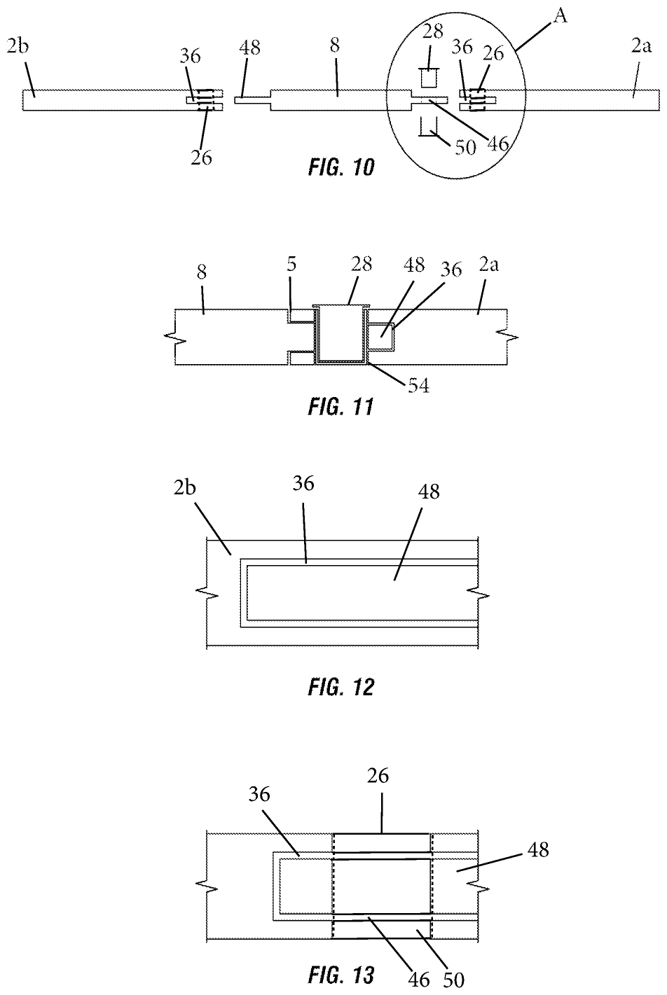

FIG. 7 illustrates a front exploded view of a sagittal bra system that exerts focalized pressure comprising a right cup holding arch 54a, left cup holding arch 54b, a right cup 56a, a left cup 56b, and at least one pressure component 8, and plurality of fasteners 28 (not shown, see FIG. 10), according to some embodiments of the present invention. Similar to the pressure components 8 used for the sagittal arch 2, there is at least one pressure component 8 worn with the sagittal bra system. The pressure component 8 can be worn on the ventral aspect of the user or on the dorsal aspect of the user. The right cup holding arch 54a and the left cup holding arch 54b have a plurality of openings 26 along the inner edge 5 and outer edge 7. The openings 26 are about ¼ inch in diameter and are used to align with the cavity 46 located on each ridge 48 and the opening 26 on the right cup 56a and the left cup 56b. Once the opening 26 and the cavity 46 are aligned, a fastener 28 is inserted to secure the cup 56a, 56b to the cup holding arches 54a, 54b. The right cup 56a and the left cup 56b are mirror versions. The right cup 56a is slidably engaged with the right cup holding arch 54a and the left cup 56b is slidably engaged with the left cup holding arch 54b as it has a ridge 48 that is slid into a channel 36 located on the outer edge 7 of each cup holding arch 54a, 54b. There are cups 54a, 54b of varied shapes, sizes and circumferences. The cups 54a, 54b are detachable using a ridge 48 that is about ½ inch in height and about ⅛ inch in width. The ridge 48 has a opening 26 that is about ¼ inch in diameter. The ridge 48 of each right cup 56a and left cup 56b slides into a channel 36 located at the outer edge 7 of the right cup holding arch 54a and at the outer edge 7 of the left cup holding arch 54b.

The right cup holding arch 54a and left cup holding arch 54b are similar to the right sagittal holster 2a and left sagittal holster 2b except the outer edge 7 of the right cup holding arch 54a and the outer edge 7 of the left cup holding arch 54b is concave having a channel 36 with a length of about ½ inch and a width of about ¼ inch that runs along the chest region 31. The channel 36 as mentioned above allows the right cup 56a and left cup 56b to engage with the right cup holding arch 54a and left cup holding arch 54b.

When the pressure component 8 is worn between the right cup holding arch 54a and left cup holding arch 54b, the length of the pressure component 8 is about 1 inch and the height is about 2 inches. The right cup 56a and the left cup 56b is about 5 inch in diameter; however other dimensions can be contemplated. The right cup holding arch 54a and left cup holding arch 54b are about ¼ inch in width near the chest region 30.

Focalized pressure can be exerted by fastening two sagittal arches 2a, 2b with two pressure components 8, the arches' clamping efficiency is transmitted from the sagittal arches 2 to the pressure components 8. The borrowed efficiency enables the pressure component 8 to exert steady focal pressure on the mediastinum region of the torso that, until now, can only be pressured resorting to wrap-around holsters. However, in some embodiments mechanisms such as springs, specifically precision springs, removable and/or interchangeable clamps and other methods of creating localized pressure by the sagittal arches 2 can be used.

The sagittal holster 1 and sagittal bra 52 are pressure gradient intensifiers because it exerts pressure. Furthermore, the pounds of pressure are adjustable. The clamping effect exerted by each sagittal arch 2a, 2b, and each cup holding arch 54a, 54b can be enhanced and/or adjusted by tensors. In some embodiments, between the front outer corner and rear outer corner of the right sagittal arch 2a and the front outer corner and rear outer corner of the left sagittal arch2b, the corners are connected by a tensor. In some embodiments, a tensor can comprise of a pair of nylon straps having a male-female buckle. In some embodiments, the tensor can comprise of a single nylon strap with a hook-and-loop feature. In yet further embodiments the tensor can be secured using buttons, snaps, hooks, threads, or zippers. The tensor slides through slits about 1 inch in height, each slit located at the lower outer corners of the right sagittal arch 2a and left sagittal arch 2b. As mentioned previously, the location of the pressure components 8 are adjustable along the height of the sagittal arches 2a, 2b. In some embodiments, the sagittal holster 1 and the sagittal bra 52 exerts pressure because it is smaller than the user. Therefore, when the user wears the sagittal holster 1, or the sagittal bra 52, it will fit tightly against the user, exerting pressure. In some embodiments, between the front outer corner and rear outer corner of the right sagittal arch 2a and the front outer corner and rear outer corner of the left sagittal arch2b, the corners are connected by a separator. The separator functions as an extra torso protector because it maintains the distance between the front outer corner and the rear outer corner of the right sagittal arch 2a and the front outer corner and the rear outer corner of the left sagittal arch 2b. The separator can be fastened to the sagittal arches 2a, 2b by screws; however, other fasteners can be contemplated. The separator can be made of a rigid metallic material.

FIG. 8A illustrates a perspective view of the pressure component 8, according to some embodiments of the present invention. FIG. 8B illustrates a front view of the pressure component 8, according to some embodiments of the present invention. In some embodiments of the pressure component 8 is an electronic tablet that lies substantially flat along the user's torso's mediastinum region. The pressure component 8 can be worn on the ventral aspect of the torso or the dorsal aspect of the torso. The pressure component 8 can be flat, slim and rigid and can be made from stainless steel, fiberglass, plastic, brass, or titanium. However, other materials can also be contemplated. As mentioned above, the pressure component 8 has a top edge 10, bottom edge 12, left edge 14, right edge 16, a body facing surface 18, an outside facing surface 20, a top surface 38, bottom surface 40, left surface 42, and right surface 44. The pressure component 8 can be used in a portrait or landscape configuration; as such the length of the edges will vary. The width of the pressure component 8 is about ¼ inch, the height is about 4 inch, and the length is about 2 inch. In some embodiments, the top surface 38 does not have any features and is substantially flat. In other embodiments, the top surface 38 comprises USB ports, SIM cards, a battery, an antenna, and/or sensor's plug. In some embodiments, the bottom surface 40 does not have any features and is substantially flat. In other embodiments, the bottom surface 40 has slots for batteries, special cards, USB ports, SIM cards, an antenna, and/or sensor's plug. There are two cavities 46 located on each ridge 48. In yet other embodiments, the pressure components 8 can have features such as slots for batteries, special cards, USB ports, SIM cards, an antenna, and/or sensor's plug.

FIG. 9 illustrates a cross sectional view of the right sagittal arch 2a and left sagittal arch 2b and the pressure component 8 along an area without an opening 26, according to some embodiments of the present invention. Along the left surface 42 and the right surface 44 of the pressure component 8 there is a ridge 48 that is about ½ inch in height and about ⅛ inch in width. The ridge 48 along the right surface 44 of the pressure component 8 slides into the channel 36 located on the inner edge 5 of the sagittal holsters 2. The ridge 48 along the left surface 42 of the pressure component 8 slides into the channel 36 located on the inner edge 5 of the sagittal holsters 2. The height of the pressure component illustrated in FIG. 9 is about 2 inches. The length of the channel 36 illustrated in FIG. 9 is about ½ inch on both of the sagittal holsters 2. The length of the right and left sagittal arch 2a, 2b, have a length of about 3 inch starting from the anterior edge 30 to the posterior edge 32.

FIG. 10 illustrates a cross sectional view at an opening 26 on the sagittal arches 2a, 2b or cup holding arches 54a, 54b according to some embodiments of the present invention. The user inserts the ridge 48 of the pressure component 8 into the channel 36 of the sagittal arches 2a, 2b or cup holding arch 54a, 54b and aligns the cavity 46 and the opening 26 so they are both even with each other. The fastener 28, such as a bolt, can then be inserted through the cavity 46 and the opening 26 and secured in a receiver 50, such as a fastener cup. The diameter of the openings 26 are about ¼ inch.

FIG. 11 illustrates a detailed view of A in FIG. 10 after the fastener secures a pressure component 8 to a sagittal arch 2a, according to some embodiments of the present invention. At least one pressure component 8 is worn on the front of the user or worn on the back of the user. When the pressure component 8 is worn attached to the sagittal arch 2a, the ridge 48 of the pressure component 8 slides past the inner edge 5 of the right sagittal arch 2a and into the channel 36. Once the ridge 48 is substantially flush against the channel 36, the opening 26 (not shown, see FIG. 10) and the cavity 46 (not shown, see FIG. 10) are align so that the fastener 28 can be inserted through both the opening 26 and the cavity 46 to secure the system together. The fastener is about ⅕ inch in diameter and about ¼ inch in length. The left sagittal arch 2b secures to the ridge 48 of the left surface 42 in a similar manner.

This mechanism of securing is also found in the sagittal bra system. The pressure component 8 is secured to the sagittal arch 2 or the cup holding arch 54 when the fastener 28 mates with a receiver 50 by first threading through an opening 26 and a cavity 46 that are align with each other. The left and right sagittal holsters 2 or the cup holding arches 54 and the front and back pressure components 8 are mated together using the fastener 28 and opening 26.

The fastener 28 according to this embodiment illustrated in FIG. 11 comprises a bolt like configuration that slides into a receiver 50. In other words, the ridge 48 slides into the channel 36 so that the opening 26 and cavity 46 line up. Then the fastener 28 is inserted into the opening 26 through the cavity 46 and secured with a receiver 50 (not shown, see FIG. 14). The receiver 50 can be configured like a cup that outlines the opening 26 so that the fastener 28 can secure the sagittal arch 2 with the pressure component 8. The sagittal holsters 2 and pressure components 8 are secured by at least two fasteners 28. Each fastener 28 can be inserted once the cavity 46 is aligned with the desired opening 26. The fasteners 28 can be about ⅕ inch in diameter by ¼ inch in length; however, other dimensions can be contemplated. Other embodiments for fasteners 28 can be screws that are about ¾ inch or 1 inch in diameter. The screws are easy to twist screws and can be made from various types of metals or nylon. The fasteners 28 can also be varied colors as well. The openings 26 are about ¼ inch in diameter and there are about ten openings 26 along the inner edge 5 of the right cup holding arch 54a and left cup holding arch 54b.

FIG. 12 illustrates a detailed cross sectional view of the concave region of the inner edge of the sagittal arch 2 or cup holding arch 54 at a location that does not have an opening 26, according to some embodiments of the present invention. The ridge 48 of the pressure component 8 slides into the channel 36. The channel 36 is concave and substantially secures the ridge 48 of the pressure component 8 such that the pressure component 8 does not move.

FIG. 13 illustrates a detailed cross sectional view of the concave region of the inner edge of the sagittal arch 2 or cup holding arch 54 at a location that comprises an opening 26, according to an embodiment of the present invention. When the ridge 48 of the pressure component 8 is substantially flush with the concave region of the channel 36, the opening 26 and the cavity 46 are align allowing the fastener 28 to be inserted and securing both the pressure component 8 with the sagittal arch 2 or cup holding arch 54. A receiver 50 can also be inserted into the opening 26 and the cavity 46 to mate with a fastener 28 or the fastener 28 can be a screw that is threaded into opening 26 and cavity 46, which also contain threads.

FIG. 14 illustrates an exploded view of a fastener 28 and receiver 50, according to some embodiments of the present invention. In this embodiment, the fastener 28 mates with a receiver 50; however, as mentioned before, the fastener 28 can be a screw without needing a receiver 50. The fastener 28 can be magnetized, a binding bolt, snap on, posts with screw, etc. The fastener 28 has a binding bolt configuration with a diameter of about ⅕ inch and a length of about ¼ inch. An embodiment of the opening 26 is a cup configuration. The binding bolt mates with the receiver 50, which in this example is a cup by sliding the binding bolt into the cup until it secures into place. In order to release the binding bolt, the user slides the binding bolt in a reverse direction.

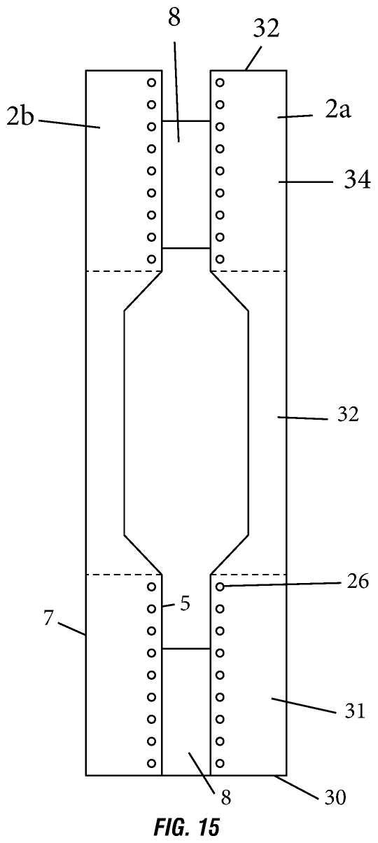

FIG. 15 illustrates a top view of a flattened left sagittal arch 2b and right sagittal arch 2a, according to some embodiments of the present invention. The height of the sagittal arch 2 is the distance between the anterior edge 30 and the posterior edge 32. The height of the sagittal arch 2 embodiment illustrated in FIG. 15 extends from the sternum region to the interscapular region of the user. Other heights can be contemplated. By default, there are two mirror versions of the sagittal arch 2 in a sagittal holster system, the right and the left sagittal arch 2a, 2b. The right sagittal arch 2a is worn on the left shoulder and the left sagittal arch 2b is worn on the right shoulder and both sit against on the user's torso, parallel to the user's mediastinum region. The right sagittal arch 2a clamps the left shoulder and the adjacent areas of the chest and upper-back. The left sagittal arch 2b clamps the right shoulder and the adjacent areas of the chest and upper back.

The sagittal arch 2 has a chest region 31, a shoulder region 32, and a back region 34. As shown in FIG. 15, the right and left sagittal arch 2a, 2b, have a length of about 3 inch starting from the inner edge 5 to the outer edge 7 at the chest region 31 and back region 34. At the shoulder region 32, the length can range from 3 inches to about 1.5 inches, preferably 1.5 inches. However other lengths are also contemplated. The openings 26 are located on the chest region 31 and back region 34 and along the inner edge 5 of the left and right sagittal arch 2a, 2b. The openings 26 are about ¼ inch in diameter and there is about a 1 inch space between each opening 26. The height of the sagittal arch 2 is the distance between the anterior edge 30 and the poster edge 32. The chest region 31 is about 8 inch in height, the shoulder region 32 is about 12 inch in height, and the back region 34 is about 8 inch in height for the right and left sagittal holsters 2a, 2b. However, other heights can be contemplated to suit the needs of different size users.

When the sagittal arch 2 and the sagittal bra 52 is not in use, it naturally has a gripping force which forces the anterior portion 22 and posterior portion 24 to clamp down on each other. In other words, the compression is exerted by the potential energy (rigidity) of the material used to make the arch. In order for the user to wear the sagittal arch 2 or the cup holding arch 54, the user pulls the anterior portion 22 and posterior portion 24 apart and places each of the sagittal arch 2 or cup holding arch 54 over the right or left shoulder. When the user releases the anterior portion 22 and the posterior portion 24, the chest region 31 and the back region 34 will naturally clamp down against the user's body. The sagittal arch 2 or the cup holding arch 54 can be flat, slim and rigid and it can be made from various materials, such as stainless steel, fiber glass, plastic, brass, or titanium. The sagittal arch 2 or cup holding arch 54 can also be made from carbon fiber or molded plastic. Once the sagittal arches 2 or cup holding arch 54 are worn in the proper the location, the user will connect the left to the right sagittal arch 2 or cup holding arch 54 by fastening the pressure component 8 to the sagittal arch 2 or cup holding arch 54.

The length of the sagittal arch 2 is the distance between the outer edge 7 and the inner edge 5 of the holster 2. In some embodiments, the length of a sagittal arch 2 is about 3 inches; however other lengths can be contemplated. The width of the sagittal arch 2 is the distance between the outside facing side 6 and the body facing side 4. In some embodiments, the width of a sagittal arch 2 is about ¼ inch; however, other widths can be contemplated. The sagittal arch 2 can have four round corners for comfort or the corners can be pointed.

Some embodiments of the sagittal arch 2 are the articulated sagittal arch which comprises a hinge at the shoulder region 32. The hinge functions by the potential energy (rigidity) of the hinge material. Mechanisms such as springs, specifically precision springs, removable and/or interchangeable clamps function by the potential energy (rigidity) of its material. These are various methods of creating localized pressure by the sagittal arch 2 and sagittal bra 52. In some embodiments, the hinge is located at the shoulder region 32. In some embodiments, the springs and/or clamps are located at the shoulder region 32.

The sagittal arch's 2 anterior edge 30, posterior edge 32, and the outer edge 7 are convex. The inner edge 5 of the shoulder region 32 is convex but the inner edge 5 at the chest region 31 and the back region 34 is concave to form a channel 36 for sliding the pressure component 8 into the channel 36. As mentioned above, the distance between each opening 26 is about 1 inch. The length of the channel 36 is about ½ inch and the width is about ⅛ inch giving a total of about ¼ inch width of the sagittal arch 2 where the channel 36 is located. On either side of the channel 36 between each opening 26 the width is about 1/16 inch. Where there is an opening 26 the body facing side 4 and the outside facing side 6 of the channel 36 is missing therefore allowing the fastener 28 to be inserted into the opening 26 and secured.

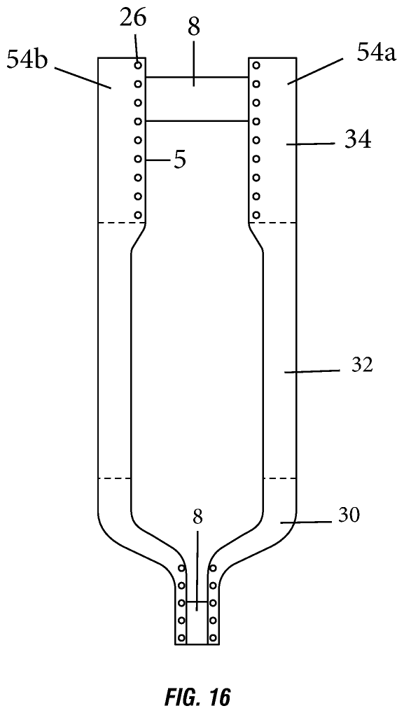

FIG. 16 illustrates a top view of a flattened left cup holding arch 54b and right cup holding arch 54a and two pressure components 8, according to some embodiments of the present invention. The sagittal bra 52 comprises a left cup holding arch 54b and a right cup holding arch 54a. The left cup holding arch 54b and a right cup holding arch 54a have a chest region 30, shoulder region 32, and a back region 34. The length of the left cup holding arch 54b and a right cup holding arch 54a at the chest region 31 can be ¾ inch. The length of the left cup holding arch 54b and a right cup holding arch 54a at the shoulder region 32 can range between 2 inches to 1.5 inches, preferably at 1.5 inches. The length of the left cup holding arch 54b and a right cup holding arch 54a at the back region 34 can be 2 inches. However other lengths are also contemplated. There are openings 26 that run substantially even along the inner edge 5 of the cub holding arches 54a, 54b. As shown in FIG. 16, the front pressure component 8 can be worn vertically along the torso and the back pressure component can be worn horizontally along the torso.

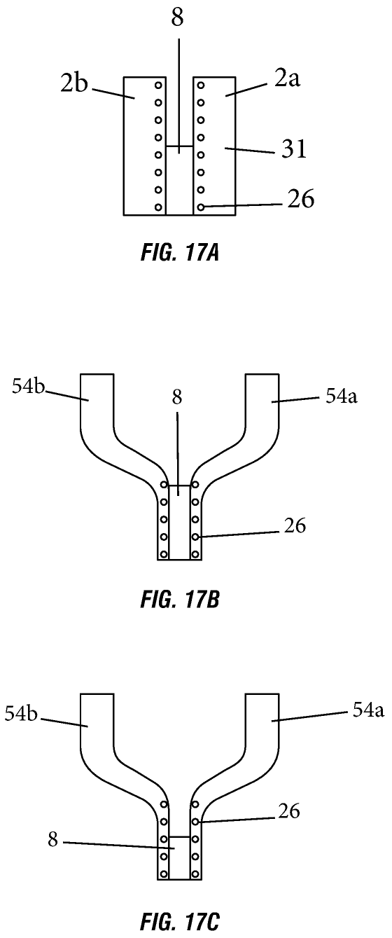

FIG. 17A illustrates a front view of another embodiment of the sagittal holster system. FIG. 17A illustrates the rectilinear embodiment used by male adults and the right sagittal arch 2a and left sagittal arch 2b is about 3 inch in length throughout the chest region 31, shoulder region 32 and back region 34. The pressure component 8 for this embodiment is about 2 inches in length and about 5 inches in height. In other embodiments, the shoulder region 32 can be 1.5 inches in length. FIG. 17B illustrates the curvilinear embodiment used by female adults. The right cup holding arch 54a and the left cup holding arch 54b is about 2 inches in length in the shoulder region 32 and about ¾ inch in length near the chest region 31. The curvilinear embodiment has a slender variation of the pressure component 8 and this variation is about 1 inch in length and about 4 inches in height. Another variation of the curvilinear embodiment is that the shoulder region 32 is about 1.5 inches in length. FIG. 17C illustrates the sagittal bra 52 embodiment used by female adults. The right cup holding arch 54a and left cup holding arch 54b is about 2 inch in length in the shoulder region 32 and about ¾ inch in length near the chest region 31. This embodiment has a pressure component 8 that when worn is about 1 inch in length and about 2 inch in height.

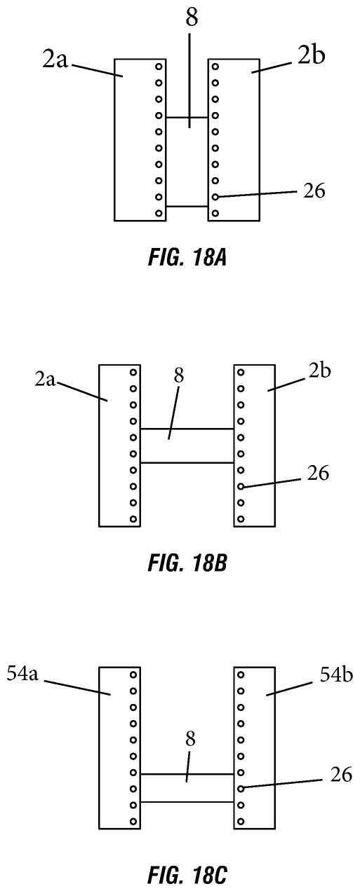

FIG. 18A illustrates a back view of the sagittal holster system, according to some embodiments of the present invention. FIG. 18A illustrates a back view of the rectilinear embodiment. The right sagittal arch 2a and left sagittal arch 2b are about 3 inches in length around the back region 34. The pressure component 8 when worn is about 2 inches in length and about 5 inches in height. FIG. 18B illustrates a back view of the curvilinear embodiment where the right sagittal holster 2a and the left sagittal holster 2b is about 2 inch in length in the back region 34. When the pressure component 8 is worn it is about 5 inch in length and about 2 inches in height. FIG. 18C illustrates the back view of a sagittal bra system embodiment used by female adults. The right cup holding arch 54a and left cup holding arch 54b are about 2 inches in length in the back region 34. In some embodiments there is a pressure component 8 that when worn is about 5 inches in length and about 1 inch in height. Of course, other sizes and shapes can also be contemplated.

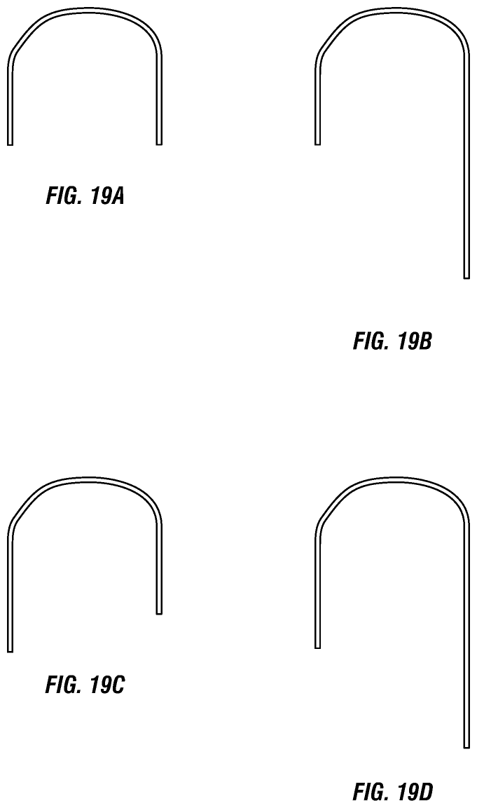

FIGS. 19A-19D illustrates various embodiments of fixed height sagittal arches 2a, 2b or cup holding arches 54a, 54b, according to an embodiment of the present invention. The height can vary depending on the therapeutic need and/or safety requirements. FIG. 19A illustrates an embodiment for a fixed height sternal to interscapular region sagittal arch 2a, 2b or cup holding arch 54a, 54b. FIG. 19B illustrates an embodiment for a fixed height sternal to lumbar region sagittal arch 2a, 2b or cup holding arch 54a, 54b. FIG. 19C illustrates an embodiment for a fixed height epigastrium to interscapular region sagittal arch 2a, 2b or cup holding arch 54a, 54b. FIG. 19D illustrates some embodiments for a fixed height epigastrium to lumbar region sagittal arch 2a, 2b or cup holding arch 54a, 54b.

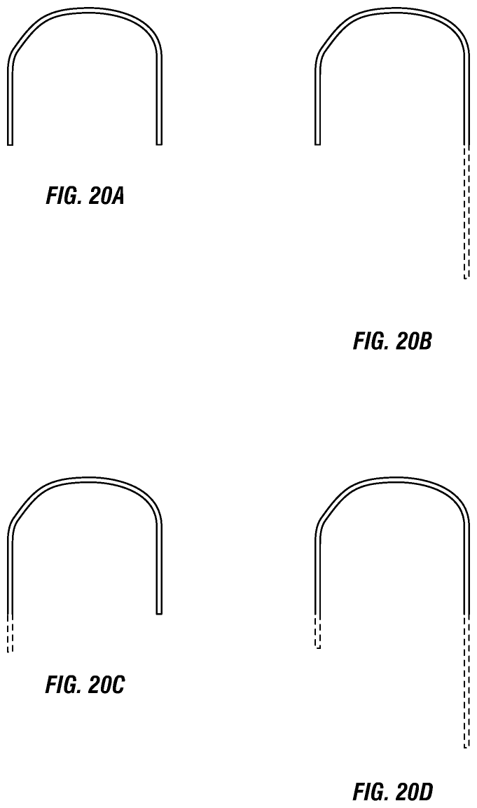

FIGS. 20A-20D illustrates various embodiments of variable height sagittal arches 2a, 2b or cup holding arches 54a, 54b, according to an embodiment of the present invention. Holsters for both fixed and variable height sagittal arches 2a, 2b or cup holding arch 54 are extensible and retractable using a mechanism similar to a collapsible cane. FIG. 20A illustrates an embodiment for a variable height sternal to interscapular region sagittal arch 2a, 2b or cup holding arch 54a, 54b. FIG. 20B illustrates an embodiment for a variable height sternal to lumbar region sagittal arch 2a, 2b or cup holding arch 54a, 54b. FIG. 20C illustrates an embodiment for a variable height epigastrium to interscapular region sagittal arch 2a, 2b or cup holding arch 54a, 54b. FIG. 20D illustrates an embodiment for a variable height epigastrium to lumbar region sagittal arch 2a, 2b or cup holding arch 54a, 54b.

Throughout the description and drawings, example embodiments are given with reference to specific configurations. It will be appreciated by those of ordinary skill in the art that the present invention can be embodied in other specific forms. Those of ordinary skill in the art would be able to practice such other embodiments without undue experimentation. The scope of the present invention, for the purpose of the present patent document, is not limited merely to the specific example embodiments or alternatives of the foregoing description.

What is claimed is:

1. A holster that exerts focalized pressure on a human torso of a user comprising:
at least two supporting units, including a first supporting unit and a second supporting unit, each of the at least two supporting units configured for wearing on each shoulder of the user, an anterior portion extending over the shoulder to a posterior portion, and
at least one pressure component, the at least one pressure component having a plurality of edges, a body facing surface and an outside facing surface; whereby
a first plurality of edges of the at least one pressure component is in contact with an inner edge of the anterior portion of the first supporting unit and a second plurality of edges of the at least one pressure component is in contact with an inner edge of the anterior portion of the second supporting unit;
wherein the first supporting unit and the second supporting unit exert a clamping effect against a mediastinum region of the human torso.

2. The holster of claim 1, further comprising a second pressure component having a first plurality of edges in contact with an inner edge of a posterior portion of the first supporting unit and a second plurality of edges in contact with an inner edge of a posterior portion of the second supporting unit.

3. The holster of claim 1, wherein a spring at a shoulder region creates the clamping effect.

3. The holster of claim 1, wherein a clamp at a shoulder region creates the clamping effect.

4. The holster of claim 1, further comprising tensors substantially near bottom corners of the at least two supporting units.

5. The holster of claim 4, wherein the tensors are nylon straps.

6. The holster of claim 4, wherein a buckle secures each end of the tensor.

7. The holster of claim 4, wherein a hook-and-loop secures each end of the tensor.

8. The holster of claim 1, wherein the inner edge of the anterior portion is a channel.

9. The holster of claim 1, wherein the inner edge of the posterior portion is a channel.

10. The holster of claim 8, wherein a length of the channel is approximately ½ inch.

11. The holster of claim 9, wherein a length of the channel is approximately ½ inch.

12. The holster of claim 1, wherein the pressure component has an opening to receive a SIM card, a USB connector, a battery, an antenna, a plug for a sensor.

13. A holster that exerts focalized pressure against surfaces of a mediastinum comprising:
a supporting unit worn on a shoulder, the supporting unit having a length extending between an outer edge and an inner edge, a width extending between a body facing side and an outside facing side, an anterior portion extending to a posterior portion beginning from an anterior edge and ending at a posterior edge.

14. The holster of claim 13, further comprising a hinge where the anterior portion transitions to the posterior portion.

15. The holster of claim 13, wherein the supporting unit is collapsible.

16. The holster of claim 13, wherein the supporting unit is made from a material selected from the group consisting of stainless steel, fiber glass, plastic, brass, titanium.

17. The holster of claim 13, wherein a clamping of the supporting unit creates the focalized pressure.

18. A method of exerting focalized pressure against surfaces of a mediastinum, the method comprising:
a) aligning an anterior portion of a first supporting unit with a ventral aspect of a torso,
b) placing the first supporting unit over a first shoulder,
c) repeating steps a) and b) with a second supporting unit over a second shoulder,
d) aligning the first supporting unit with the second supporting unit,
g) mating a first pressure component into the first supporting unit and the second supporting unit.

19. The method of claim 18, further comprising enhancing focalized pressure using tensors.

20. The method of claim 18, further comprising mating a second pressure component with the first supporting unit and the second supporting unit.
